(19) United States
(12) Patent Application Publication
(10) Pub. No.: US 2009/0196015 A1
(43) Pub. Date: Aug. 6, 2009

(54) Lighting module with wavelength converting structure and manufacturing method for the same

(75) Inventors: Hsin-Tao Huang, Zhubei City (TW); Chun-Chung Hsiao, Caotun Township (TW)

Correspondence Address: BACON & THOMAS, PLLC, 625 SLATERS LANE, FOURTH FLOOR, ALEXANDRIA, VA, 22314-1176, US

(73) Assignee: KISMART CORPORATION, Taipei City (TW)

(21) Appl. No.: 12/068,144

(22) Filed: Feb. 4, 2008

(51) Int. Cl. F21V 9/16; H01J 9/00

(52) U.S. Cl. 362/84; 445/23

(57) ABSTRACT

The present invention relates to a lighting module and manufacturing Method for the Same, and more particularly, to a lighting module with a flat wavelength converting structure for reducing mura. The lighting module provided by the present invention includes a frame, one or more light sources disposed on the frame, and a flat wavelength converting structure shared by the light sources for emitting light with aimed wavelength; the present invention provides a lighting module emitting light with mura that insensible to eye or with lower mura at elevated diffusion angle compared to that provided by the traditional one; therefore, the present invention also provides a lighting module occupying smaller volume; or a lighting module with fewer light sources and sharing the similar thickness of the traditional one, which emits light with similar or lower mura compared to the traditional one.

### FIELD OF THE INVENTION

The present invention relates to a lighting module and more particularly to a lighting module with a flat wavelength converting structure for reducing mura, thereby reducing the volume of lighting module and/or the number of light sources it needs.

### DESCRIPTION OF THE PRIOR ART

The trend of flat panel is toward developing a large size and thin flat panel; wherein flat light sources with large emitting area is important for lighting modules in manufacturing large-sized flat panel liquid crystal displays with reduced structure.

The traditional lighting module with cold cathode fluorescent lamp CCFL has the shortcomings list below. The light with wavelength 185 nm generated during discharge causes a new absorptive spectrum band and the brightness of emitting light may degraded with time. Moreover, the recombination of the Hg+ and ions and the electrons at the tube wall disrupt the lattice structure of the phosphor powder would exaggerate the brightness degradation of the emitting light. Moreover, for CCFL, the phosphor coating and the light emitting source have to be disposed in the same vacuum lamp tube, and it is difficult to produce large-sized lamps and provide wavelength conversions in large areas with CCFL. Another disadvantage is that the phosphor coating mentioned above is uneven in most cases. In conventional CCFL manufacturing process, the phosphor slurry is siphoned to the top of the standing lamp tube, and then coated the interior wall thereof from the top to the bottom by gravity; therefore, phosphor layer is uneven in most cases; the phenomenon is more obvious, while the lamp is a large-size tube.

Other light sources, including external electrode fluorescent lamps (EEFL), light emitting diodes (LED), carbon nanotubes (CNT), flat fluorescent lamps (FFL), and organic light emitting displays (OLED) is either immature for production (e.g., LED, CNT, OLED and FFL) or inapplicable for large-size application; more importantly, these existing light source is expensive and complex for being a large-size flat light source.

Furthermore, the diffusion angle of the lighting module is determined by the distance between the light sources or the distance between the light source and the diffusion plate. While the distance between the light source and the diffusion plate decreases, the phenomenon of interference and reflection of light become more obvious and therefore the illumination difference, which also referred to as mura, becomes more serious. While the distance between the light sources increases, the same phenomenon occurs, for the intensity of illumination of each light source decreases with distance. Hence, while developing a thin flat panel by increasing the diffusion angle, the elevated mura effect accompanied is a serious problem to be solved.

To provide a lighting module with less mura, the traditional way is to provide a diffusion plate with diffusion particles or with ink on the surface; the former and latter solutions may lower the luminance of emitting light, and latter also requires aligning the position of ink with the light source with high precision. Many inventions have been provided. Some are provide inventions relating to improve the optical character of diffusion plate. U.S. Pat. No. 7,290,921 provides a light guide plate with sub-scattering-dots for producing uniform emitting light. The technical feature of this invention is providing scattering-dots and sub-scattering-dots at a predetermined region on the bottom surface of said light guide; wherein at least one sub-scattering-dot is disposed around each scattering-dot and the sub-scattering-dots are smaller than the scattering-dots. U.S. Pat. No. 7,018,059 provides a direct type backlight module; wherein, a diffuser plate disposed on the reflector, and the lamps are disposed between the reflector and the diffuser plate. This invention provides a light-distributing device to inhibit mura effect; the light distributing device is a prism plate, a metallic film with a plurality of holes or a light guide plate with various indexes of refraction thereon.

Some are relating to the mechanical structures of lighting module. Japanese Publication No. 2001-210126, discloses a direct type backlight module with supporting assemblies disposed under the lamps to prevent deformation of the lamps; therefore, the diffuser can be maintained at a predetermined position by the columns to prevent the mura effect. Taiwan patent No. 552440 provides a direct type backlight module with an improved fixing structure for the optical films to prevent mura defects. U.S. Pat. 7,125,157 provides a backlight unit including a frame, a first supporting portion, a second supporting portion, and a film; wherein the film comprises a first constraining portion and a second constraining portion. The film is positioned on the frame by the first and the second supporting portion passing through the first and the second constraining portion, respectively. When the frame is disposed in a first position, the first supporting portion partially contacts an inner wall of the first constraining portion for positioning the film. When the frame is disposed in a second position, the second supporting portion partially contacts an inner wall of the second constraining portion for positioning the film.

Some are provided with improve surface character. U.S. Pat. 7,172,331 provides a direct type backlight module having a holding structure for holding a reflector on a frame, instead of using an adhesive to prevent roughness and unevenness in reflector's surface when the reflector is attached onto the surface of frame.

A solution provides lighting module having a flat light source emitting light with lower mura and with reduced structure volume and/or the number of light sources has not provided yet. In view of the above, the subject invention provides a lighting module with flat wavelength converting structure to provide flat light source and emitting light with these advantages.

### SUMMARY OF THE INVENTION

One advantage of the present invention is providing a lighting module with a flat converter to reduce mura of emitting light.

Another advantage of the present invention is providing a lighting module with lower mura at high diffusion angle compared to the traditional one.

Another advantage of the present invention is providing a lighting module occupying smaller volume.

Another advantage of the present invention is providing a lighting module with flat light source applicable to large size application.

Another advantage of the present invention is providing a lighting source with uniform lighting area.

Another advantage of the present invention is providing a lighting module with fewer light sources and sharing the similar thickness of the traditional one, which emits light with similar or lower mura compared to the traditional one.

The present invention provides a lighting module comprising: a frame, a light source disposed on said frame with a support, and a flat light converting structure for converting incident light into emitting light with aimed wavelength disposed on said light source; wherein a diffusion angle representing a spatial arrangement of said light source and said light converting structure is less than 160 degrees.

### BRIEF DESCRIPTION OF THE DRAWINGS

FIG. 1 illustrates a cross-sectional view of a lighting module;

FIG. 2 illustrates the spatial arrangement of the light source and the shared flat converter in a lighting module;

FIG. 3 illustrates a luminance difference of the light emitted from a traditional lighting module;

FIG. 4 illustrates a luminance difference of the lighting module of the present invention;

FIG. 5 illustrates another luminance difference of the lighting module of the present invention;

FIG. 6 illustrates the non uniformity ratio of the visible light emitted from two lighting module at different diffusion angle.

### DESCRIPTION OF THE PREFERRED EMBODIMENT

The invention will now be described in greater detail with preferred embodiments of the invention and illustrations attached. Nevertheless, it should be recognized that the preferred embodiments of the invention is only for illustration. Besides the preferred embodiment mentioned here, present invention can be practiced in a wide range of other embodiments besides those explicitly described, and the scope of the present invention is expressly—not limited by the embodiments but determined by the accompanying Claims.

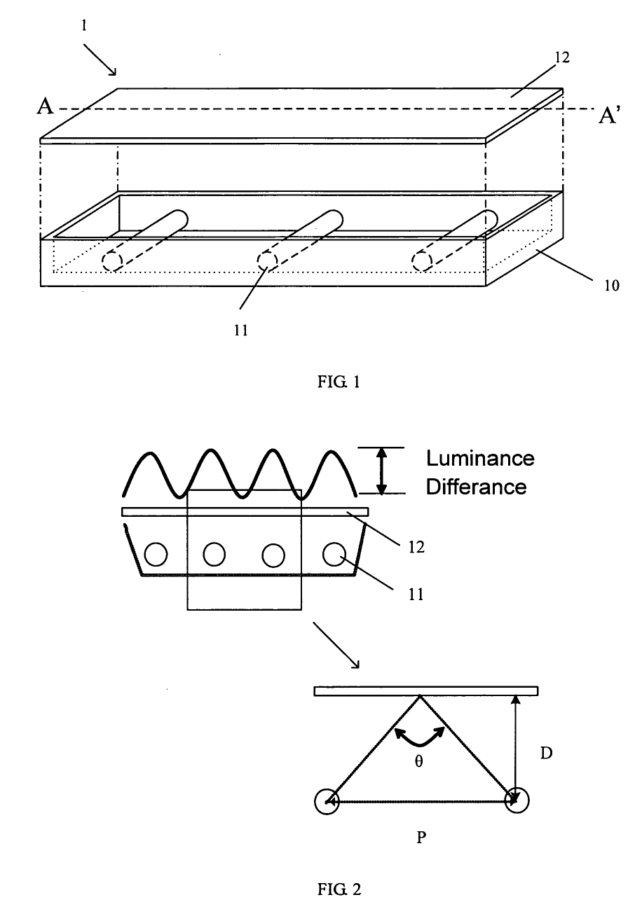

FIG. 1 is a cross-sectional view of a lighting module 1 including a frame 10, multiple light sources 11, and a flat wavelength converting structure 12 disposed upon the multiple light sources 11 (hereinafter referred to as flat converter); wherein the flat converter 12 comprising one or more optical structures.

In one embodiment, the present invention provides a lighting module with an UVc lamp and a flat converter coated with a layer of phosphor. The structure and functional details of this lighting module are described in U.S. patent application Ser. No. 11/940,845 “Flat converting structure and Manufacture and Use of the Same” incorporated here as a reference in its entirety for embodying the present invention; the description hereafter summarize some features of this embodiment but non-limiting.

Referring to FIG. 1 of the present specification, this embodiment discloses a light source 11 for providing incident light to the flat converter 12. The light source 11 is an UVc lamp; UVc denotes the wavelength ranges no more than 280 nm; in another embodiment, the range of the wavelength falls between 200 nm to 280 nm, and more particularly from 250 nm to 260 nm; the preferred wavelength is 253.7 nm. In another embodiment, the light source 11 emits light other than UVc light, e.g., the light source 11 is LED or other lightening device, as long as the emitting light of said light source is suitable for a corresponding flat converter to provide the aimed wavelength.

The light source 11 is disposed in the frame 10 by a supporting structure; the light source 11 can be plural UV lamps lined up in the frame or a LEDs matrix or other 2-dimention arranged lightening device. In a preferred embodiment, the inner surface of the frame 10 also applied a reflection plate (not shown) for reflecting light emitted from the light source 11 toward the flat converter 12.

Referring to FIG. 1 again, the present invention also discloses a flat converter 12 for converting the wavelength of the incident light into the aimed wavelength, for guiding the light, for diffusing the light, and for acting as a uniform planar light source. In one embodiment, the flat converter 12 is disposed upon the multiple light source 11 by supporting structure; therefore, the converter 12 is disposed on the multiple light sources 11 and the wavelength converting area of the converter 12 is shared by the light sources 11.

In one embodiment, the flat converter is a composite structure comprising a substrate and a wavelength coating disposed on or in the substrate with an anti-UVc adhesive; in a preferred embodiment, the substrate is a transparent or misty optical structure and the wavelength converting coating is a layer of phosphor excitable by UVc light. In addition to the embodiments mentioned above, the flat converter comprises a wavelength converting layer for converting incident light into aimed wavelength; the wavelength converting layer can be a uniform layer, a uneven layer, a layer arranged with a specially arranged contour or a layer with patterns at specific area to acquire the aimed level of luminance or luminance difference, according to the embodiments. In another embodiment, the wavelength converting structure can be divided into several regions with different materials, patterns, refractive index or optical characters, according to the embodiment.

In another embodiment, a reflecting plate is disposed on the inner surface of the frame and therefore the luminance of the emitting light is enhanced and the mura effect of that is reduced.

In still another embodiment, a phosphor layer is applied on the reflecting plate, and therefore, in some cases, for example, the light source is UVc light, the reflecting plate with the phosphor coating further increases the luminance and uniformity of the emitting light.

The material and optical structures for forming the composite layers of the flat converter are disclosed in U.S. patent application Ser. No. 11/940,845. In another embodiment of the present invention, the flat converter can also be made by a photo luminescent material, a fluorescent color-conversion-media, a organic complex material, a luminescent pigments, a quantum dots-based material, a quantum wire-based material, or a quantum well-based material or the combination thereof, as long as the materials of the flat converter are suitable for converting incident light into aimed wavelength.

FIG. 2 of the present specification illustrates the detailed spatial arrangement of the light source 11 and the flat converter 12 of the lighting module 1 disclosed by the present invention; wherein, as shown in FIG. 2, “P” denotes the distance between center of the two light sources, “D” denotes the vertical distance between the bottom surface of the flat converter 12 and the center of the light source 11 and “θ” denotes the diffusion angle; the numerical value of the diffusion angle can be express as 2 tan−1((P/2)/D).

Accordingly, we can widen the diffusion angle by increasing the value of p or decreasing the value of d for thin lighting module design. Because the traditional lighting module utilizes the CCFL, a kind of linear light source, as the light source, the problem of undesired mura effect would happens, as the diffusion angle rises The present invention therefore discloses a lighting module with low mura and more specifically to say, with lower mura compared to the traditional ones at high diffusion angle.

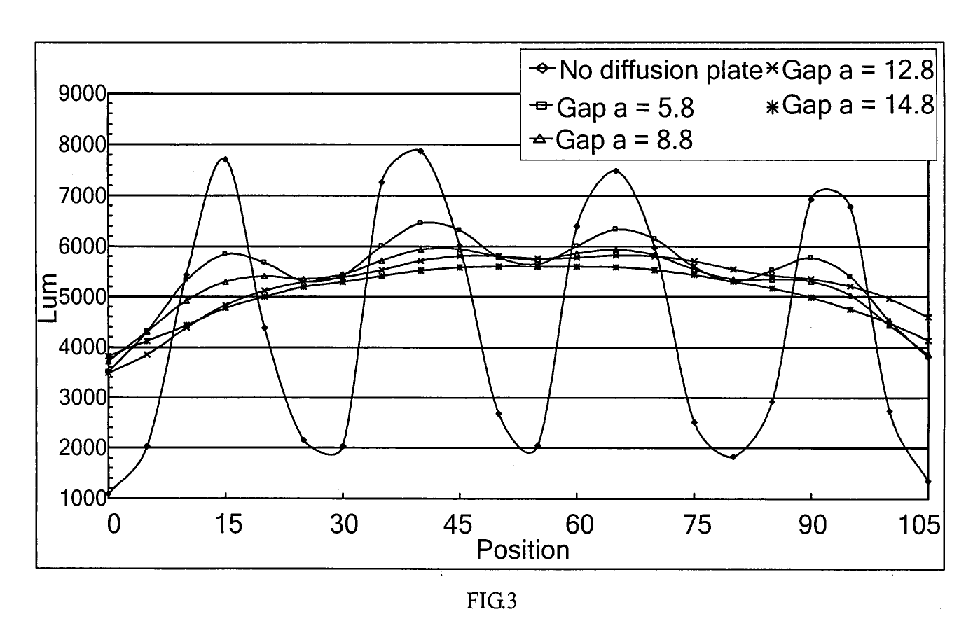

FIG. 3 illustrates luminance difference of control experiments; wherein the light source is UVc lamp (P=25 mm) and the substrate is a diffusion plate without wavelength converting coating coated therein or thereon. The luminance difference is sampled along the Line A-A′ (hereinafter represents by “X direction”) shown in FIG. 1.

Referring to FIG. 3, the curve with ⋄ symbol represents the luminance difference of the lighting module without diffusion plate; the other curves show the luminance difference of the lighting module with a diffusion plate at different θ; wherein, θ is around 130.2, 109.7, 88.6 and 80.4 degrees while D is 5.8, 8.8, 12.8, 14.8 mm respectively. The magnitude of luminance difference is less while the diffusion plate added.

As shown in FIG. 3, the luminance difference is lowered while the diffusion plate is added, but the non-uniformity ratio (non-uniformity ratio=(luminance difference (nit))/200) is still larger than 1 in most situation. While D=14.8 mm, we can find that the illumination at the position around 35-75 cm is lower than 1; in this situation, the diffusion angle is around or lower than 80 degrees. Therefore, we can find that even adding a diffusion plate, the visible light emitted form a lighting module equipped with CCFL still have problem with elevated high mura at diffusion at high diffusion angle.

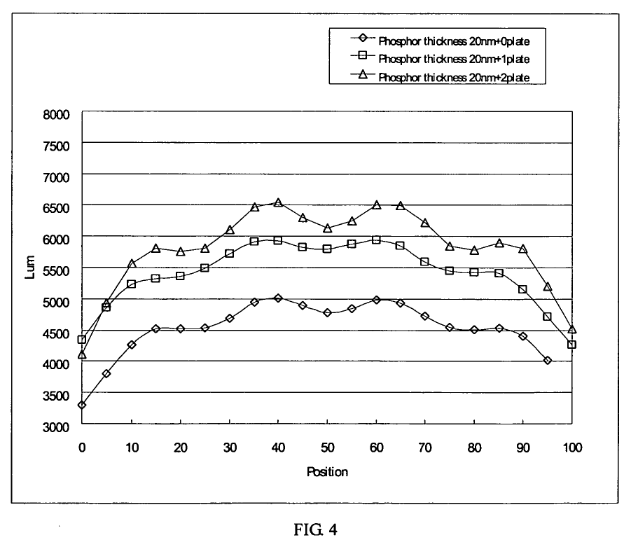

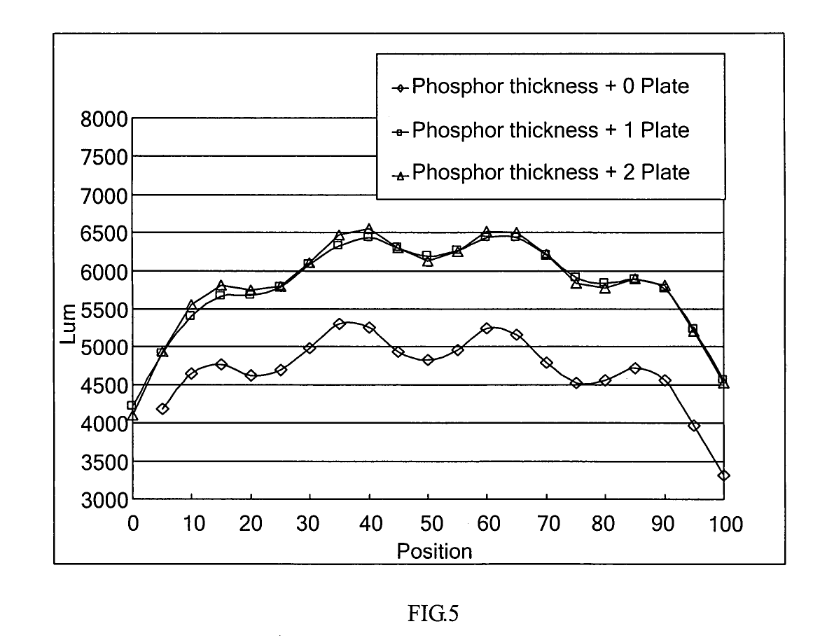

FIG. 4 and FIG. 5 illustrates a luminance difference of the lighting module of the present invention with different layers of diffusion plate provided by the present invention respectively. FIG. 4 illustrates the illumination disbribution of light emitted by a lighting module with D=8.8 mm and FIG. 5 illustrates the illumination disbribution of light emitted by a lighting module with D=5.8 mm; wherein the diffusion angle is around 130 degrees while D=5.8 mm and the diffusion angle is around 109 degrees while D=8.8 mm. Comparing with FIG. 3, the luminance difference is lower than that showed in FIG. 3 with or without the diffusion plate.

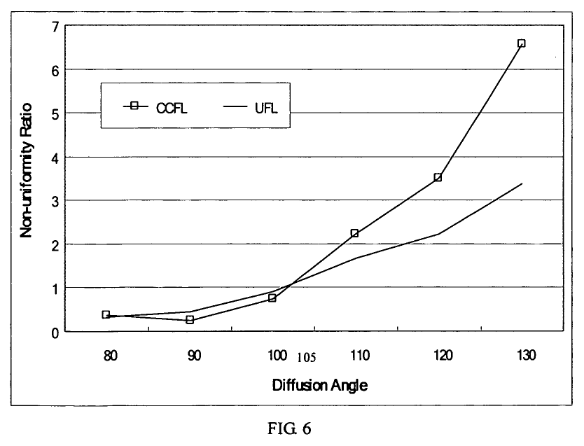

FIG. 6 illustrates the non-uniformity ratio of the visible light emitted from traditional CCFL backlight module and the present invention respectively at different diffusion angle; wherein the line with symbol ▪ represents the luminance difference of the lighting module with the present invention and the line with symbol ▴ is the one with CCFL. As shown in FIG. 6, while the diffusion angle is below around 100 degrees, the non-uniformity ratio of the each lighting module is below 1, which means the emitting light is visually smooth and uniform; while the diffusion angle goes beyond around 105 degrees, the non-uniformity ratio of the each lighting module is higher than 1, but the lighting module provided by the present invention still provides a visible light with much lower non-uniformity comparing to that provided by the traditional one. In a preferred embodiment, the θ is calculated by simulation and verified by experiment; the preferred θ is lower than 160 degrees.

Therefore, the present invention discloses a structure providing more uniform emitting visible light comparing with the lighting module without the wavelength converting structure. Furthermore, the present invention provides a flat light source with similar luminance to that of the traditional one. The lighting module of the present invention further acquires the advantage of structural simplicity, preparation with ease and readiness for large size lighting with low mura comparing to the traditional lighting module without the flat converter; more specifically to say, the lighting module disclosed by the present invention provides visible light with less non-uniformity ratio at high diffusion angle compared to the traditional one; that is, the vertical distance between bottom surface of the flat converter and the center of the light source can be shorter; therefore, the present invention provides a lighting module occupying smaller volume; or a lighting module with fewer light sources and sharing the similar thickness of the traditional one, which emits light with similar or lower mura compared to the traditional one.

The descriptions hereunder disclose the technical feature of the flat converter more specifically. the wavelength structure coating is arranged between the light and the substrate; In another embodiment, referring to FIG. 2B of U.S. patent application Ser. No. 11/940,845, the first wavelength converting coating 3051 coated on one side of the substrate 3053 facing the light source 303 and the second wavelength converting coating 307 is disposed on the interior wall of the frame 301; wherein the materials of the first wavelength converting coating 3051 and the second wavelength converting coating 307 aren't necessary the same. A wavelength converting coating is optionally applied on the light source holder 207 against UV_{c} light.

The present embodiment also discloses a UV-blocking coating. The UVc light source may also emit small amount of light with wavelength 320 nm to 400 nm; to avoid interference, the present invention discloses a UV-blocking coating for absorbing UV light in the range 320 to 400 nm in avoid of UV light leakage or causing interference to the utilization of UVc light. In one embodiment, As illustrated in FIG. 4B of U.S. patent application Ser. No. 11/940,84, a wavelength converting coating 4051, a substrate 4053 and a UV-blocking coating 4055 forming a stacked optical structure; Alternatively, as shown in FIG. 4C, the UV-blocking coating 4055 is disposed on the same side with wavelength converting coating 4051. In a preferred embodiment, to further block leakage of UV light, a UV-blocking coating is applied on the interior surface of frame. The material of the UV-blocking coating is disclosed in U.S. patent application Ser. No. 11/940,845 incorporated here as reference.

According to the present invention, the volume or weight ratio of the phosphor power and the adhesive is within a specific range and average particle size of the phosphor powder is relevant to the thickness of the coating. In one embodiment, the thickness of the converting coating is about 2 to about 10 times the average particle size of the phosphor powder; in a preferred embodiment, the thickness of the converting coating is about 3 to about 5 times the average particle size of the phosphor powder.

The adhesive is a macromolecular material. In another embodiment, the preferred adhesive is an anti-UVC material for preventing the yellowing of the wavelength converting coating and the degradation of the adhesive itself.

In another embodiment, the multiple wavelength converting coating can form a laminated, stacking structure to improve light emitting efficiency and prevent UVc light leakage.

In another embodiment, the lighting module comprises an optical structure to change the optical property of the emitting light, for example, the uniformity, brightness, polarization or any combination thereof; the wavelength converting structure may comprise any appropriate optical elements, for example, a prism, an optical film or sheet such as a diffusion plate, a diffusion film, a brightness enhancement film (BEF), a dual brightness enhancement film (DBEF), a prism plate, a lenticular film, a polarizer, a diffusion plate with screen printing or any combinations thereof.

The present invention discloses a lighting module comprising a frame, one or more light source disposed on said frame, a flat light converting structure for converting incident light into emitting light with aimed wavelength disposed on, which means placing the flat light converting structure in front of the light path, and shared by the light source; wherein a diffusion angle representing a spatial arrangement of the light source and the light converting structure is lower than 160 degrees.

The present invention also discloses a method for forming the back light module. In one embodiment, the present invention provides a lighting module with an UVc lamp and a flat converter coated with a layer of phosphor; the process for forming a flat converter is disclosed by U.S. patent application Ser. No. 11/940,845 “Flat converting structure and Manufacture and Use of the Same” is incorporated here as reference in its entirety for embodying the present invention; the description hereafter summarize some features of this embodiment but non-limiting.

The present invention discloses a method for forming a lighting module with flat converter. A slurry is prepared with a ratio of the phosphor powder, adhesive and organic solvent and then coated on a substrate for forming wavelength converting coating. In a preferred embodiment, the weight ratio of the organic solvent in the slurry ranges from about 20 wt % to about 80 wt %, and preferably ranges from about 35 wt % to about 55 wt % to have the desired viscosity of the slurry; wherein the preferred viscosity of slurry is from 10 cps to 10000 cps. Optionally, other components can be added to the slurry to prolong the service life of the wavelength converting structure includes (but is not limited to) a stabilizer, an absorbent, a blocker, or combinations thereof to avoid any adverse effect on the performance of the wavelength converting structure, these components are typically added in a total amount of no more than 10 wt % based on the total weight of the slurry. Subsequently, the solvent is removed through a drying process to form the desired wavelength converting coating. Other detail for forming the flat converter, for example the materials for constituting the wavelength converting coating and the substrate, can cross refer to U.S. patent application Ser. No. 11/940,845.

The detailed process for constructing this process comprises arranging a light source on the bottom of a frame with a support; wherein the light source can be arrange in line, in the form of matrix or other arrangement suitable for providing incident light to a converter. A converter prepared according to the process disclosed above is disposed upon the light source by supporting post 2075 illustrated in FIG. 2B of U.S. patent application Ser. No. 11/940,845; in a preferred embodiment, the flat converter is fixed by a fixing device disclosed by U.S. patent application Ser. No. 11/940,845. In another embodiment, the position of optical structures is decide by embodiment, for example, in one embodiment, the wavelength converting coating deposited on one side of the substrate or between the optical layers of the structure, depending upon the light source selected; in another embodiment, other optical structures, for example, diffusion plate, may also provided if needed.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A lighting module comprising:
a frame;
one or more light source disposed in said frame;
a flat light converting structure for converting incident light into emitting light with aimed wavelength disposed on and shared by said light source; wherein a diffusion angle representing a spatial arrangement of said light source and said light converting structure is lower than 160 degrees.

2. The lighting module of claim 1, wherein said diffusion angle is higher than 105 degrees.

3. The lighting module of claim 1, wherein said flat wavelength converting structure is a structure with uniform surface, a uneven surface, or a structure with patterns at specific area.

4. The lighting module of claim 1, wherein said flat wavelength converting structure is divided into different areas with different optical character.

5. The lighting module of claim 4, wherein said area is with different thickness, with different material, with different pattern or with any combination thereof.

6. The lighting module of claim 1, wherein said flat light converting structure comprises a wavelength converting layer and a substrate.

7. The lighting module of claim 6, wherein said substrate is a diffusion plate.

8. The lighting module of claim 1, wherein the material of said flat light converting structure comprises phosphor powder, photo luminescent layer, fluorescent color-conversion-media, organic complex material, luminescent pigments, quantum dots-based material, quantum wire-based material or quantum well-based material or any combination thereof.

9. The lighting module of claim 1, wherein said light source is an UVc lamp, an LED or other lighting device providing said incident light suitable for said flat wavelength converting structure to provide said aimed wavelength.

10. The lighting module of claim 1, further comprising a reflecting plate disposed on the inner surface of said frame.

11. The lighting module of claim 10, wherein a phosphor layer is coated on said reflecting plate.

12. The lighting module of claim 1, wherein said aimed wavelength of emitting light is within the range of visible light.

13. The lighting module of claim 1, further comprising an optical structure for changing the optical property of said emitting light.

14. The lighting module of claim 13, wherein said optical structure is a prism, an optical film or sheet such as a diffusion plate, a diffusion film, a brightness enhancement film (BEF), a dual brightness enhancement film (DBEF), a prism plate, a lenticular film, a polarizer, a diffusion plate with screen printing or any combinations thereof.

15. The method for forming a lighting module, comprising:
providing a frame;
placing a light source on said frame with a support;
preparing a flat wavelength converting structure, wherein said flat light converting structure is for converting incident light into emitting light with aimed wavelength;
placing said wavelength converting structure on said light source; wherein the diffusion angle is less than 160 degrees.

16. The method of claim 15, wherein said flat wavelength converting structure comprising phosphor powder layer, photo luminescent layer, fluorescent color-conversion-media, a structure having organic complex material, a structure with luminescent pigments, a structure having quantum dots-based material, a structure having quantum wire-based material or structure having quantum well-based material or any combination thereof.

17. The method of claim 15, wherein said preparing a flat wavelength converting structure comprising:
providing a substrate;
preparing a slurry, wherein said slurry comprises a phosphor powder, an anti-UVC powder and a solvent;
coating said slurry on a surface of said substrate for forming a wavelength converting structure; and
drying said coated substrate.

18. The method of claim 17, wherein the viscosity of said slurry is controlled within a range from 10 cps to 10000 cps.

19. The method of claim 17, wherein said organic solvent is 20 wt % to about 80 wt % to the total weight of said slurry.

20. The method of claim 17, wherein said slurry also comprising stabilizer, an absorbent, a blocker, or combinations thereof; wherein said stabilizer, an absorbent, a blocker, or combinations thereof is no more than 10 wt % to the total weight of said slurry.
